(19) United States
(12) Patent Application Publication
(10) Pub. No.: US 2015/0375470 A1
(43) Pub. Date: Dec. 31, 2015

(54) DEVICE FOR PREVENTING ADHESION OF SLICED MATTERS

(71) Applicant: Young-won KIM, Daejeon (KR)

(72) Inventor: Young-won KIM, Daejeon (KR)

(21) Appl. No.: 14/744,935

(22) Filed: Jun. 19, 2015

(30) Foreign Application Priority Data
Jun. 25, 2014 (KR) 10-2014-0078315

(51) Int. Cl. B32B 3/02; B32B 9/04; B32B 3/26

(52) U.S. Cl. CPC B32B 3/02; B32B 3/263; B32B 9/04; B32B 2250/02

(57) ABSTRACT

A detachable device for preventing sliced food ingredients from sticking on the blade of a knife when a user slices the food ingredients. The device is attached to a kitchen knife and acts to bend food ingredients outwardly from the blade. It includes an adhesion preventing member having a predetermined length and width, and having a flat lower face. The adhesion preventing member includes a curved portion, a first inclined portion and a second inclined portion which are respectively formed on the upper part thereof. The curved portion has an arc-shaped curved surface and the first inclined portion extends downwardly from an end portion while forming a curved surface. The second inclined portion extends downwardly from the other end portion while forming a curved surface. A silicon attachment pad is joined to the lower face of the adhesion preventing member.

### BACKGROUND OF THE INVENTION

1. Field of the Invention

The present invention relates to a device for preventing adhesion of sliced matters, and more particularly, to a device for preventing adhesion of sliced matters which is detachably attached to the blade of a kitchen knife in order to prevent sliced food ingredients from sticking on the blade of the knife when a user slices various food ingredients, such as fruits, vegetables, tofu, and others, thereby enabling the user to effectively slice or cut various food ingredients.

2. Background Art

In general, when a user cuts or slices various food ingredients, such as vegetables, fruits, tofu and others, using a kitchen knife, the sliced food ingredients are adhered onto both sides or one side of the blade, and hence, it deteriorates efficiency in slicing or cutting the food ingredients and causes inconvenience that the user has to take off the sliced food ingredients adhered on the blade.

As described above, the reason why the sliced food ingredients are adhered on the blade is that pectin compounds, moisture and others contained in the food ingredients are interposed between the surface of the blade and the surface of each sliced food ingredient, which respectively have smooth surfaces and get in contact with each other, and temporarily act as adhesives between the two surfaces.

That is, as described above, the sliced food ingredients are adhered on the blade, the cutting speed get slowed because the user has to slice or cut the food ingredients while taking off the sliced food ingredients adhered on the blade with the hand, and especially, in case that the user slices the food ingredients fast, the conventional kitchen knife has inconvenience in use because the food ingredients adhered on the blade fall from and are bounced off the blade by a fast movement of the blade and the sliced food ingredients are scattered disorderly.

Korean Patent No. 1153208 discloses a “detachable device for preventing adhesion of sliced food ingredients” (prior art 1). In the prior art, the detachable device for preventing adhesion of sliced food ingredients which is detachably attached to a kitchen knife comprises: a blade attachment plate of a thin plate which has a predetermined the radius of curvature and an arc-shaped curved surface and of which a lower blade comes into line contact with the side of the blade with elastically repelling power; one or more suction plates mounted on the blade attachment plate and attached to the side of the kitchen knife by suction force; and over-flips mounted near to the lower blade of the blade attachment plate in order to bend the sliced food ingredients backwardly from the blade. The detachable device for preventing adhesion of sliced food ingredients can directly separate the sliced food ingredients from the blade, can be attached even to stainless steel knife which is made of a nonferrous material, and does not prevents slicing or cutting.

However, the detachable device for preventing adhesion of sliced food ingredients which includes the suction plates attached to the blade of the kitchen knife according to the prior art has several problems in that it is not easy to attach the suction plates to the blade and the suction plates frequently come off the blade during cutting because a sharp portion of the blade is different in the degree of inclination from a unsharp blade body and in that it is inconvenient to cut or slice small food ingredients because the device is large-sized.

### PRIOR ARTS

Prior Art 1: Korean Patent No. 1153208 entitled “detachable device for preventing adhesion of sliced food ingredients”

### SUMMARY OF THE INVENTION

Accordingly, the present invention has been made to solve the above-mentioned problems occurring in the prior arts, and it is an object of the present invention to provide a detachable device for preventing adhesion of sliced food ingredients which can be easily detachably attached to the blade without using any absorbing means because the attachment pad is absorbed to the surface of the blade while being contracted when the user presses the attachment pad made of silicon to the surface of the blade, and which can prevent the sliced food ingredients from being scattered disorderly by falling from and being bounced off the blade because the adhesion preventing member separates the sliced food ingredients outwardly from the blade, thereby arranging the sliced food ingredients neatly without being adhered on the blade while being separated from the blade.

To accomplish the above object, according to the present invention, there is provided a detachable device for preventing adhesion of sliced food ingredients which is attached to a kitchen knife in order to bend food ingredients sliced by a blade outwardly from the blade, including: an adhesion preventing member of a plate type having predetermined length and width and having a flat lower face, the adhesion preventing member including a curved portion, a first inclined portion and a second inclined portion which are respectively formed on the upper part thereof, the curved portion having an arc-shaped curved surface, the first inclined portion extending to be inclined downwardly while forming a curved surface from an end portion of the longitudinal direction of the curved portion to the outside of the longitudinal direction, the second inclined portion extending to be inclined downwardly while forming a curved surface from the other end portion of the longitudinal direction of the curved portion to the outside of the longitudinal direction; and an attachment pad joined to the lower face of the adhesion preventing member and made of silicon.

Moreover, the adhesion preventing member is made of one of ceramics, hard synthetic resin and aluminum.

Furthermore, the curved portion of the adhesion preventing member is downwardly inclined from the central portion toward the width direction end portion of the adhesion preventing member.

Additionally, the first inclined portion is larger in inclination angle than the second inclined portion.

In addition, the outside end edges of the first inclined portion and the second inclined portion are rounded.

Moreover, the outside end edges of the first inclined portion and the second inclined portion are rounded in different sizes.

Furthermore, the curved portion has an auxiliary protrusion which extends from an end portion which meeting the second inclined portion to the inclined surface of the second inclined portion and which protrudes to be upwardly inclined.

Additionally, the attachment pad includes attachment recesses formed on the lower face thereof.

In addition, the adhesion preventing member includes a joining groove which is formed on the upper face by being cut along the outer edge thereof, and the outer end portion of the attachment pad is extended and seated on the joining groove to be joined with the joining groove.

Furthermore, the adhesion preventing member includes a suction plate fixing groove of a concave form formed in the lower face of the center thereof in a predetermined size, and one or more suction plates are fixed to the suction plate fixing grooves so as to be attached to the side of the kitchen knife by suction force.

According to the preferred embodiment of the present invention, the detachable device for preventing adhesion of sliced food ingredients can be easily detachably attached to the blade without using any absorbing means because the attachment pad is absorbed to the surface of the blade while being contracted when the user presses the attachment pad made of silicon to the surface of the blade, and can prevent the sliced food ingredients from being scattered disorderly by falling from and being bounced off the blade because the adhesion preventing member separates the sliced food ingredients outwardly from the blade, so that the sliced food ingredients are not adhered on the blade and are arranged neatly while being separated from the blade.

### BRIEF DESCRIPTION OF THE DRAWINGS

The above and other objects, features and advantages the present invention will be apparent from the following detailed description of the preferred embodiments of the invention in conjunction with the accompanying drawings, in which:

FIG. 1 is a perspective view showing a used state of a detachable device for preventing adhesion of sliced food ingredients according to a preferred embodiment of the present invention;

FIG. 2 is a perspective view of the detachable device for preventing adhesion of sliced food ingredients;

FIG. 3 is a plan view of the detachable device for preventing adhesion of sliced food ingredients;

FIGS. 4a and 4b are sectional views taken along the line of A-A and the line of B-B of FIG. 3;

FIGS. 5a to 5c are sectional views showing various examples of the detachable device for preventing adhesion of sliced food ingredients; and

FIG. 6 is a view showing a state where the detachable device for preventing adhesion of sliced food ingredients is attached to a blade.

### DETAILED DESCRIPTION OF THE PREFERRED EMBODIMENT

Reference will be now made in detail to the preferred embodiments of the present invention with reference to the attached drawings. However, it will be understood by those of ordinary skill in the art that the preferred embodiments of the present invention are all exemplified and the present invention is not limited to such embodiments.

Hereinafter, according to the preferred embodiments, a technical structure of the present invention will be described in detail as follows.

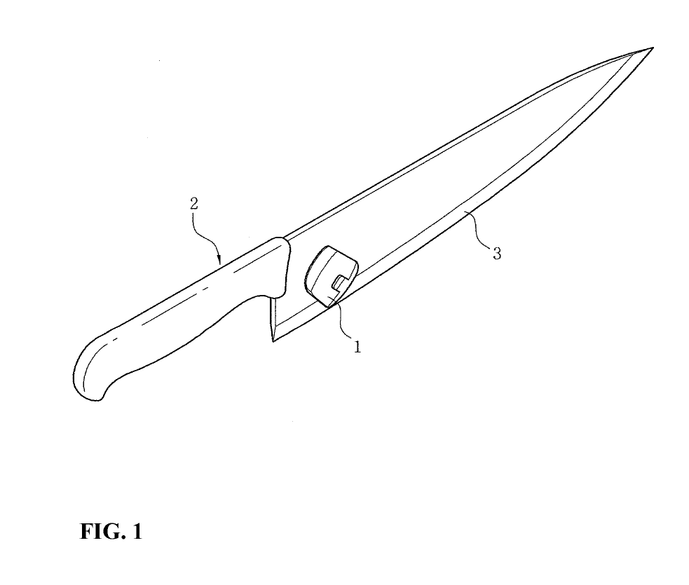

FIG. 1 is a perspective view showing a used state of a detachable device for preventing adhesion of sliced food ingredients according to a preferred embodiment of the present invention.

As shown in FIG. 1, the detachable device 1 for preventing adhesion of sliced food ingredients according to the present invention is attached to one side of a blade 3 of a kitchen knife 2 in order to prevent sliced food ingredients from being adhered on the surface of the blade when a user slices or cuts various food ingredients, such as fruits, vegetables, tofu and others, such that the user can effectively slice or cut various food ingredients.

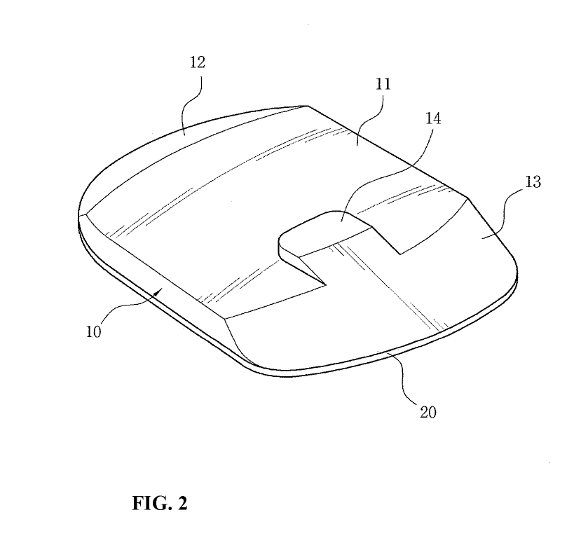

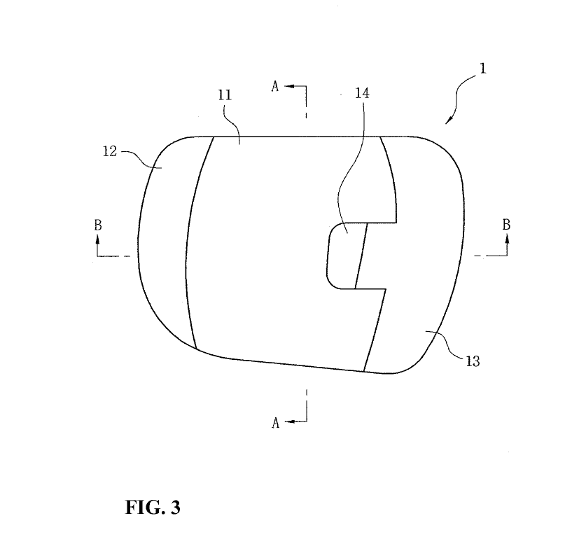

FIG. 2 is a perspective view of the detachable device for preventing adhesion of sliced food ingredients, and FIG. 3 is a plan view of the detachable device for preventing adhesion of sliced food ingredients.

The detachable device 1 for preventing adhesion of sliced food ingredients according to the preferred embodiment of the present invention includes: an attachment pad 20 attached to the blade 3; and an adhesion preventing member 10 formed on the attachment pad 20 in order to push the sliced food ingredients outwardly from the blade 3.

The adhesion preventing member 10 is a plate type having predetermined length and width, has a flat lower face, and includes a curved portion 11, a first inclined portion 12 and second inclined portion 13 which are respectively formed on the upper part thereof, wherein the curved portion 11 has an arc-shaped curved surface, the first inclined portion 12 extends to be inclined downwardly while forming a curved surface from an end portion of the longitudinal direction of the curved portion 11 to the outside of the longitudinal direction, and the second inclined portion 13 extends to be inclined downwardly while forming a curved surface from the other end portion of the longitudinal direction of the curved portion 11 to the outside of the longitudinal direction.

That is, the adhesion preventing member 10 is formed in a plate type of a predetermined size, and has the flat lower face which is joined with the attachment pad 20 and the upper face which is downwardly inclined from the central portion to the outside.

The curved portion 11 has the arc-shaped curved surface formed at the upper face. The reason why the curved portion 11 has the arc-shaped curved surface formed at the upper face is to prevent the food ingredients sliced along the first inclined portion 12 or the second inclined portion 13 from being adhered on the curved portion 11. That is, because the sliced or cut food ingredients have flat surfaces, they are not adhered on the blade due to the curved surface of the curved portion 11.

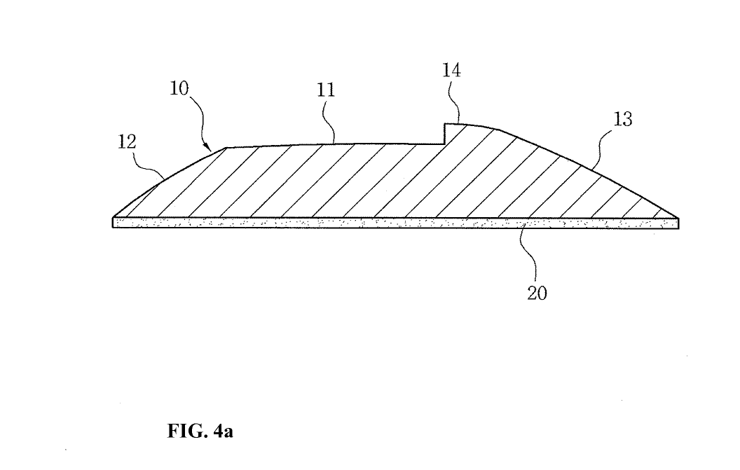

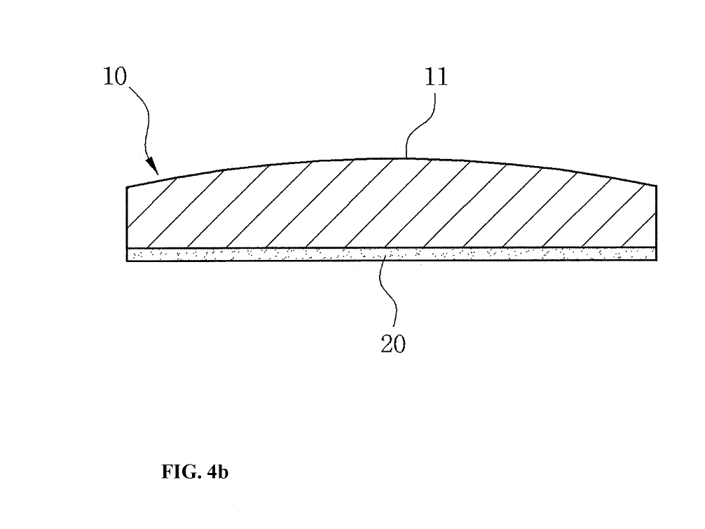

FIGS. 4a and 4b are sectional views taken along the line of A-A and the line of B-B of FIG. 3.

As shown in FIG. 4a, the first inclined portion 12 and the second inclined portion 13 respectively extend from both longitudinal direction sides of the curved portion 11, wherein the first inclined portion 12 and the second inclined portion 13 are respectively inclined in the downward direction from both end portions of the longitudinal direction of the curved portion 11.

In this instance, the upper faces of the first inclined portion 12 and the second inclined portion 13 are curved, such that the sliced food ingredients are not adhered thereon.

As described above, in order to promote convenience in use, the first inclined portion 12 and the second inclined portion 13 are selectively attached to the blade 3 in such a way as to be directed downwardly.

As described above, when the first inclined portion 12 and the second inclined portion 13 are formed at both longitudinal direction sides of the curved portion 11, the food ingredients sliced or cut by the blade are pushed outwardly from the blade 3 along the inclined surface of the first inclined portion 12 or the second inclined portion, such that the food ingredients are not adhered on the blade 3.

Moreover, as shown in FIG. 4b, the curved portion 11 of the adhesion preventing member 10 may be downwardly inclined from the central portion toward the outside end portion in the width direction.

Even though the curved portion 11 is inclined in the width direction and the sliced food ingredients are inserted in any direction of the upper face of the adhesion preventing member 10, the sliced food ingredients are not adhered on the upper face of the adhesion preventing member 10.

Furthermore, as shown in FIG. 4a, an inclination angle of the first inclined portion 12 may be different from an inclination angle of the second inclined portion 13, for instance, the inclination angle of the first inclined portion 12 is larger than the inclination angle of the second inclined portion 13.

As described above, when the first inclined portion 12 is different from the second inclined portion 13 in inclination angle, the user can selectively attach the first inclined portion 12 which has the larger inclination angle or the second inclined portion 13 which has the smaller inclination angle to the blade, while placing the inclined side down, according to characteristics of food ingredients, so that the user can selectively use the inclined portions according to characteristics of various food ingredients.

Additionally, as shown in FIG. 3, the outside end edges of the first inclined portion 12 and the second inclined portion 13 may be rounded.

The reason why the outside end edges of the first inclined portion 12 and the second inclined portion 13 are rounded is to prevent adhesion of the sliced food ingredients to the blade 3 by extending a contact area between the lower end portion of the blade 3 and the inclined portion because the edge is attached to the blade 3 to be fit to the lower end portion of the blade 3 when the user attaches the detachable device 1 to the blade 3.

In addition, the outside end edges of the first inclined portion 12 and the second inclined portion 13 may be rounded in different sizes in order to enable the user to selectively use the edges which have the rounded size appropriate to situations according to characteristics of the food ingredients.

As described above, the adhesion preventing member 10 may be made of various materials, and especially, made of a hard material such that the adhesion preventing member 10 is not forced out when the user cuts or slices the food ingredients.

Particularly, the adhesion preventing member 10 may be made of one of ceramics, hard synthetic resin and aluminum.

Moreover, the curved portion 11 has an auxiliary protrusion 14 which extends from an end portion which meeting the second inclined portion 13 to the inclined surface of the second inclined portion 13 and which protrudes to be upwardly inclined, whereby the sliced food ingredients are farther away from the blade 3.

The attachment pad 20 is joined to the lower face of the adhesion preventing member 10 by one of various known methods, such as adhesives or an adhesive sheet, and is made of silicon.

The attachment pad 20 can be attached to one side of the blade 3 without using additional absorbing means. The attachment pad 20 is made of silicon which is harmless to humans. In order to attach the attachment pad 20 to the blade 3, when the user presses the attachment pad 20 in a state where the attachment pad 20 gets in contact with the blade 3, an area that the attachment pad 20 is attached to the blade 3 is enlarged while the attachment pad 20 is pressed down, and then, when the user relieves pressure, the attachment pad 20 is absorbed onto the blade 3 while the area of the attachment pad 20 is reduced.

Alternatively, when temperature of the blade 3 is increased and the attachment pad 20 is pressed, the attachment pad 20 can be attached to the blade 3 by the same action.

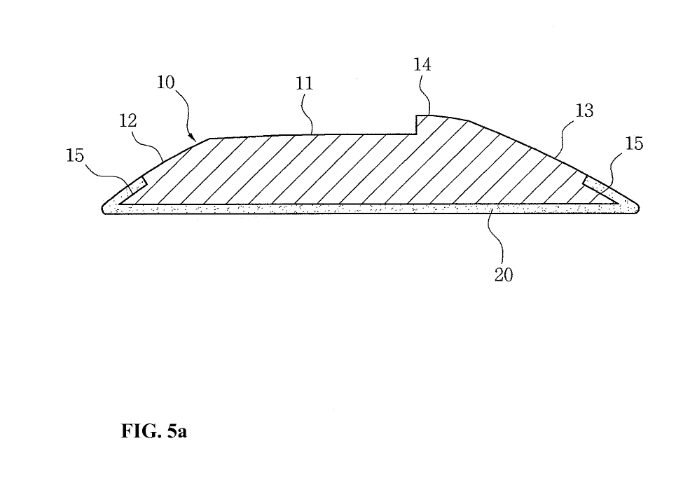

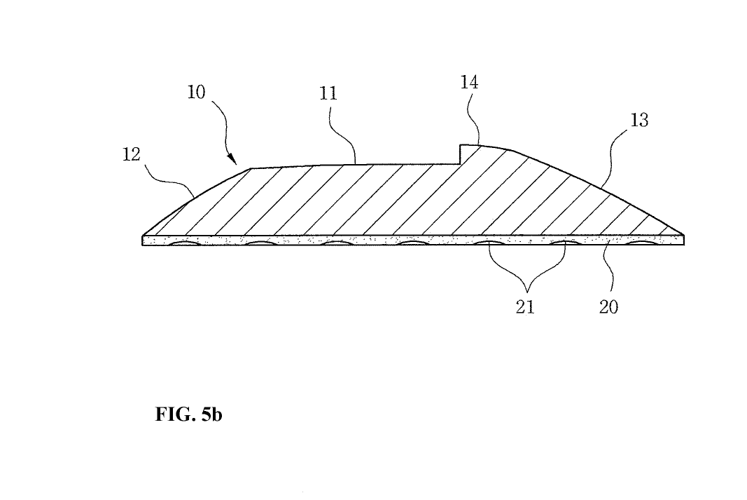

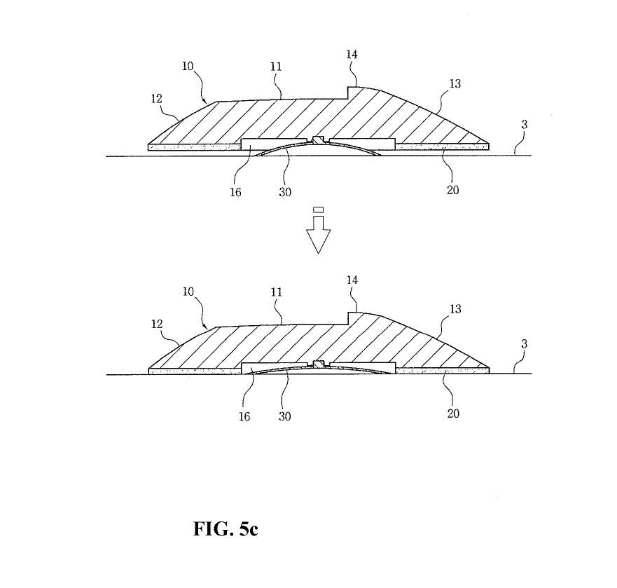

FIGS. 5a to 5c are sectional views showing various examples of the detachable device for preventing adhesion of sliced food ingredients.

As shown in FIG. 5a, the attachment pad 20 includes attachment recesses 21 formed on the lower face thereof and spaced apart from one another at regular intervals.

As described above, because the attachment recesses 21 are formed, when the detachable device 1 according to the preferred embodiment of the present invention is attached to the blade 3, the inside air of the attachment recess 21 gets out of the attachment recess 21, and when pressure is relieved, the inside of the attachment recess 21 becomes in a vacuum state, such that the attachment pad 20 is absorbed to the blade 3. Therefore, the attachment recesses 21 together with the attachment pad 20 increase attachment performance to the surface of the blade 3.

Furthermore, as shown in FIG. 5b, the adhesion preventing member 10 includes a joining groove 15 which is formed on the upper face by being cut along the outer edge thereof, and the outer end portion of the attachment pad 20 is extended and seated on the joining groove 15 to be joined with the joining groove 15, such that the attachment pad 20 can be forcedly fit and fixed to the lower part of the adhesion preventing member 10 without using adhesives.

The reason to form the joining groove 15 is to prevent the attachment pad 20 from being caught and separated from the adhesion preventing member 10 because the end portion of the attachment pad 20 does not protrude above the upper portion of the adhesion preventing member 10 and has the same surface level as the adhesion preventing member 10.

Moreover, as shown in FIG. 5c, the adhesion preventing member 10 includes a suction plate fixing groove 16 of a concave form formed in the lower face of the center thereof in a predetermined size, and one or more suction plates 30 are fixed to the suction plate fixing grooves 16 so as to be attached to the side of the kitchen knife by suction force, such that the adhesion preventing member 10 is excellently absorbed to the blade 3 by suction force of the suction plates 30.

When the suction plates 30 are formed, even though suction force of the attachment pad 20 is decreased due to a long-term use, the attachment pad 20 can be firmly attached to the blade 3 by means of suction force of the suction plates 30.

Because the suction plates 30 somewhat protrude from the suction plate fixing grooves 16, when the user presses and attaches the detachable device 1 to the blade 3, the inside air of the suction plates 30 get out of the suction plates 30, and when the user relieves pressure, the inside of each suction plate creates a vacuum, such that the detachable device 1 is absorbed to the blade 3.

If the suction plates 30 do not protrude from the suction plate fixing grooves 16, even though the user presses the detachable device 1, the detachable device 1 is not attached to the blade 3 because the suction plates 30 are not pressed even though the detachable device 1 is pressed.

The suction plate 30 may be one of various known suction plates. Alternatively, the suction plate 30 may have a fixing protrusion formed on one side thereof and the suction plate fixing groove 16 may have a fixing groove formed at the central portion, such that the suction plate 30 may be forcedly fixed to the suction plate fixing groove 16.

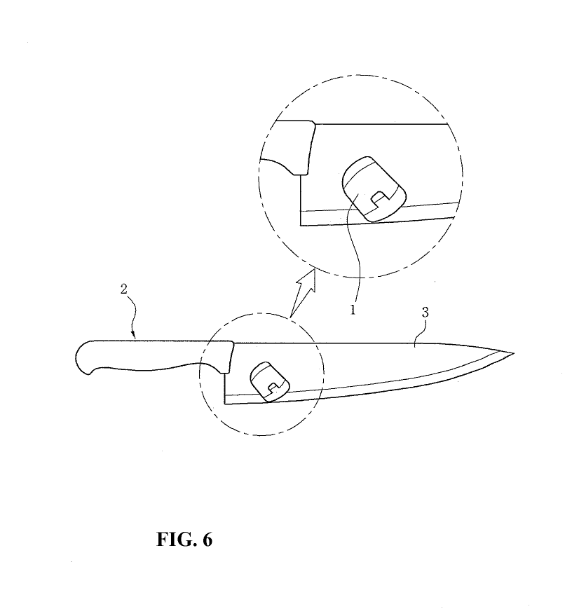

FIG. 6 is a view showing a state where the detachable device for preventing adhesion of sliced food ingredients is attached to a blade.

As shown in FIG. 6, the detachable device 1 for preventing adhesion of sliced matters according to the preferred embodiment of the present invention is attached to the blade 3 while placing the edge side down, and in this instance, the edge coincides with the lower end portion of the blade 3. Because the user does not slice or cut food ingredients with the blade 3 perpendicularly but slices or cuts the food ingredients while pushing the blade 3 forward, when the first inclined portion 12 or the second inclined portion 13 coincides with the progress direction of the blade 3, the sliced food ingredients fall outwardly from the blade 3 along the upper face of the first inclined portion 12 or the second inclined portion 13.

As described above, the detachable device for preventing adhesion of sliced food ingredients according to the preferred embodiment of the present invention can be easily detachably attached to the blade without using any absorbing means because the attachment pad is absorbed to the surface of the blade while being contracted when the user presses the attachment pad made of silicon to the surface of the blade, and can prevent the sliced food ingredients from being scattered disorderly by falling from and being bounced off the blade because the adhesion preventing member separates the sliced food ingredients outwardly from the blade, so that the sliced food ingredients are not adhered on the blade and are arranged neatly while being separated from the blade.

Although the present invention has been described in detail reference to its presently preferred embodiment, it will be understood by those skilled in the art that various changes, modifications and equivalents can be made without departing from the spirit and scope of the present invention, and the present invention is not to be restricted by the embodiments but only by the appended claims.

What is claimed is:

1. A detachable device for preventing adhesion of sliced food ingredients which is attached to a kitchen knife in order to bend food ingredients sliced by a blade outwardly from the blade, the detachable device comprising:
an adhesion preventing member of a plate type having predetermined length and width and having a flat lower face, the adhesion preventing member including a curved portion, a first inclined portion and a second inclined portion which are respectively formed on the upper part thereof, the curved portion having an arc-shaped curved surface, the first inclined portion extending to be inclined downwardly while forming a curved surface from an end portion of the longitudinal direction of the curved portion to the outside of the longitudinal direction, the second inclined portion extending to be inclined downwardly while forming a curved surface from the other end portion of the longitudinal direction of the curved portion to the outside of the longitudinal direction; and
an attachment pad joined to the lower face of the adhesion preventing member and made of silicon.

2. The detachable device for preventing adhesion of sliced food ingredients according to claim 1, wherein the adhesion preventing member is made of one of ceramics, hard synthetic resin and aluminum.

3. The detachable device for preventing adhesion of sliced food ingredients according to claim 1, wherein the curved portion of the adhesion preventing member is downwardly inclined from the central portion toward the width direction end portion of the adhesion preventing member.

4. The detachable device for preventing adhesion of sliced food ingredients according to claim 1, wherein the first inclined portion is larger in inclination angle than the second inclined portion.

5. The detachable device for preventing adhesion of sliced food ingredients according to claim 1, wherein the outside end edges of the first inclined portion and the second inclined portion are rounded.

6. The detachable device for preventing adhesion of sliced food ingredients according to claim 5, wherein the outside end edges of the first inclined portion and the second inclined portion are rounded in different sizes.

7. The detachable device for preventing adhesion of sliced food ingredients according to claim 1, wherein the curved portion has an auxiliary protrusion which extends from an end portion which meeting the second inclined portion to the inclined surface of the second inclined portion and which protrudes to be upwardly inclined.

8. The detachable device for preventing adhesion of sliced food ingredients according to claim 1, wherein the attachment pad includes attachment recesses formed on the lower face thereof.

9. The detachable device for preventing adhesion of sliced food ingredients according to claim 1, wherein the adhesion preventing member includes a joining groove which is formed on the upper face by being cut along the outer edge thereof, and
wherein the outer end portion of the attachment pad is extended and seated on the joining groove to be joined with the joining groove.

10. The detachable device for preventing adhesion of sliced food ingredients according to claim 1, wherein the adhesion preventing member includes a suction plate fixing groove of a concave form formed in the lower face of the center thereof in a predetermined size, and
wherein one or more suction plates are fixed to the suction plate fixing grooves so as to be attached to the side of the kitchen knife by suction force.
